(19) United States
(12) Patent Application Publication
(10) Pub. No.: US 2017/0116470 A1
(43) Pub. Date: Apr. 27, 2017

(54) SYSTEM AND METHOD FOR AUTOMATED SENSING OF EMOTION BASED ON FACIAL EXPRESSION ANALYSIS

(71) Applicant: Vadu Inc., St. Albert (CA)

(72) Inventors: Jason S. RANDHAWA, St. Albert (CA); David SUH, St. Albert (CA); Lorenzo PASUTTO, Edmonton (CA)

(21) Appl. No.: 15/297,747

(22) Filed: Oct. 19, 2016

Related U.S. Application Data
(60) Provisional application No. 62/244,393, filed on Oct. 21, 2015.
(60) Provisional application No. 62/244,402, filed on Oct. 21, 2015.

(51) Int. Cl. G06K 9/00; H04W 4/14; H04L 12/58; H04L 29/08; H04N 5/232; H04N 5/77

(52) U.S. Cl. CPC G06K 9/00315; G06K 9/00228; H04N 5/23293; H04N 5/77; H04L 51/22; H04L 67/02; H04W 4/14

(57) ABSTRACT

Disclosed are a system and a method for generating a feedback message in real-time indicative of an emotional response of a person during an interaction with another person, the system including at least one camera, a processing facility that receives a sequence of image frames from the camera, each image frame including the image of a person's face, and a receiver device that receives a feedback message from the processing facility indicative of an emotion of the person.

The present application claims priority to U.S. Provisional Patent Application No. 62/244,402, filed Oct. 21, 2015, and U.S. Provisional Patent Application No. 62/244,393, filed Oct. 21, 2015, which is hereby incorporated herein in its entirety.

### FIELD OF THE INVENTION

The present invention relates to a system and a method for automated, real-time sensing of a person's emotion based on the person's facial expression.

### BACKGROUND OF THE INVENTION

When a human subject interacts with another human subject or a machine, the subject may experience emotions which manifest in facial expressions. Such personal interactions includes person-to-person interactions, and person-with-machine interactions. In a face-to-face interaction (for example, an interview or examination of a patient), or a face-to-face business transaction (for example, a sales transaction) it may be important to properly appreciate and properly interpret the attitude of the subject participating in the interaction. For example, an experienced sales professional looks for a response from the customer to assess the customer's attitude in order to provide helpful assistance.

A subject's response in an interaction may be direct. For example, a customer in a business transaction may directly and verbally accept an offer, reject the offer, ask questions, make a counter-offer, inquire about alternatives (e.g. offers on other products or services) and so on.

A subject's response may also be indirect and non-verbal. For example, the customer's facial expression may inform a sales professional regarding the customer's state of mind. The customer, for example, may appear satisfied, may appear confused, may appear displeased, and so on. The careful interpretation of such non-verbal responses by the sales professional can lead to an appropriate action to improve the quality of the service provided during the transaction.

It is well known that not all people, for example sales professionals, have the same skills for properly understanding and responding to non-verbal responses, for example, non-verbal responses from a customer engaged in a transaction. Thus, many opportunities for concluding an interaction, for example “closing a sale”, are lost due to misinterpretation or lack of appreciation of a customer's non-verbal responses.

It is well known that a person's facial expression is indicative of his/her emotional states. Techniques have been developed to identify a human emotion based on a facial expression. There are systems, for example, that rely on Facial Action Coding System (FACS) to assess a person's emotion based on his/her facial expression.

Some proposed systems for automatic and real time identification of a person's emotions based on his/her facial expression rely on the automatic analysis of an image captured by a camera. For example, U.S. Pat. No. 7,379,568 proposes a robot that may be capable of identifying a human emotion through automated analysis of images captured by a camera. Specifically, U.S. Pat. No. 7,379,568 proposes a system that captures images, identifies whether there is an image of a person's face present in the captured images, and if so analyzes the person's face automatically for an expression indicative of anger, disgust, fear, joy, sadness and surprise. Other systems have also been proposed to identify an emotion of a person based on the analysis of the facial expressions of the person.

### SUMMARY OF THE INVENTION

It is well known that a personal interaction (e.g. a face-to-face commercial transaction) can occur relatively quickly. Thus, for example, in a retail environment, quick and accurate perception of a customer's attitude toward an offer is important.

A system that can quickly assess the attitude of a subject in an interaction (e.g. the customer's attitude) based on the subject's non-verbal responses is thus of great commercial value.

It is an object of the present invention to provide a system and a method to determine the emotional, non-verbal response of a subject in an interaction (e.g. the emotional and non-verbal response of a customer during a commercial transaction such as a sales transaction), and to generate a feedback message indicating the subject's response (e.g. the response to a salesperson during a sales, service or similar transaction), in order to understand, and thus improve, the quality of the service being provided during the interaction.

Other features and advantages of the present invention will become apparent from the following description of the invention which refers to the accompanying drawings.

### BRIEF DESCRIPTION OF THE DRAWING(S)

FIG. 1 schematically illustrates a first embodiment of a system according to the present invention.

FIG. 2 schematically illustrates a second embodiment of a system according to the present invention.

FIG. 3 illustrates a method according to the present invention.

FIG. 4 illustrates and example of an expression file generated by a system according to the present invention.

FIG. 5 shows examples of feedback messages displayed by a receiver device in a system according to the present invention.

FIGS. 6A and 6B illustrate a process performed by a system according to the present invention.

FIG. 6C illustrates an embodiment of a process performed by a system according to the present invention.

### DETAILED DESCRIPTION OF EMBODIMENTS OF THE INVENTION

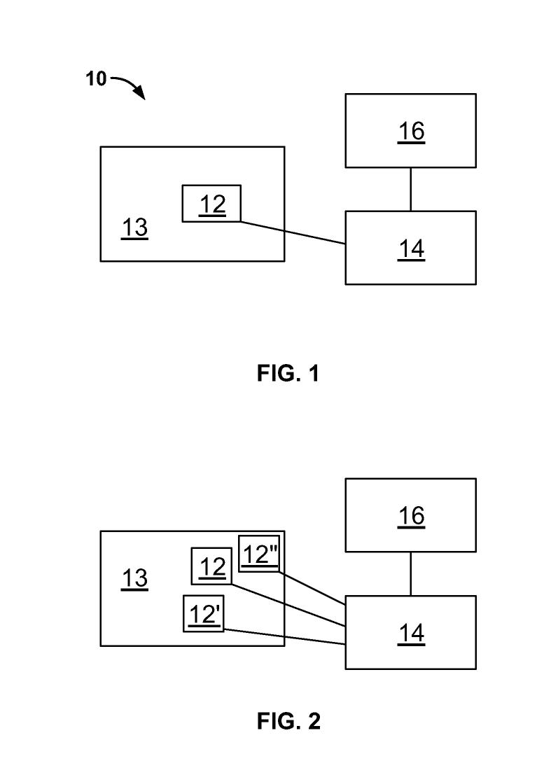

Referring to FIG. 1, a system 10 according to the present invention includes a camera 12, a processing facility 14, and a receiver device 16.

Camera 12 is in communication with processing facility 14 and transmits images to processing facility 14. Camera 12 is preferably a digital camera that is configured to transmit a digital video to processing facility 14, although other image sensors (e.g. an analog camera) could also be used. As is known, a digital video is comprised of a plurality of sequentially ordered digital image frames, each image frame including digital information based on which an image may be displayed on an electronic display, such as a computer monitor.

Camera 12 may be configured to transmit a video at any suitable frame rate and any suitable resolution.

Camera 12 may transmit the image frames to the processing facility 14 through a wired connection or through a wireless connection.

The processing facility 14 may include one or a plurality of computers configured to perform a process according to a method set forth herein. Each computer may include at least one central processing unit (CPU) (i.e. a microprocessor) or a plurality of CPUs, a non-transitory computer-readable memory device, which is capable of storing computer code for the execution of a method as described herein by the CPU, and a volatile computer-readable memory device in which data can be stored temporarily (e.g. a RAM device).

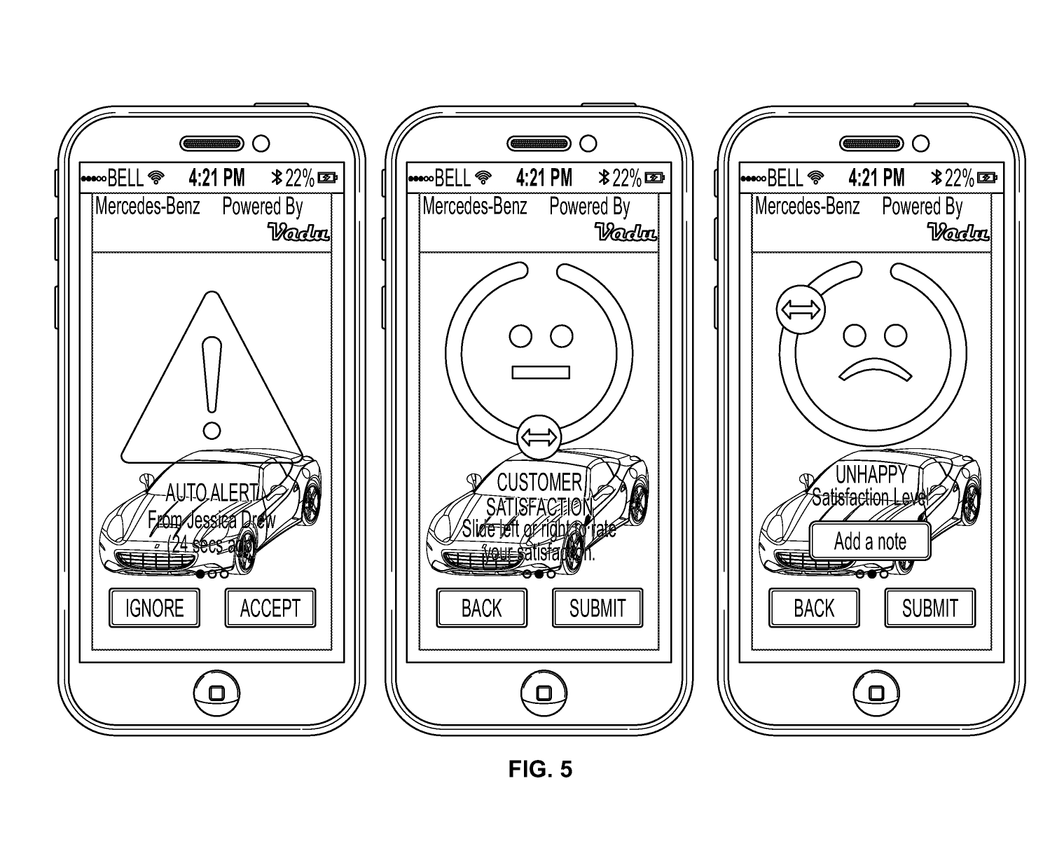

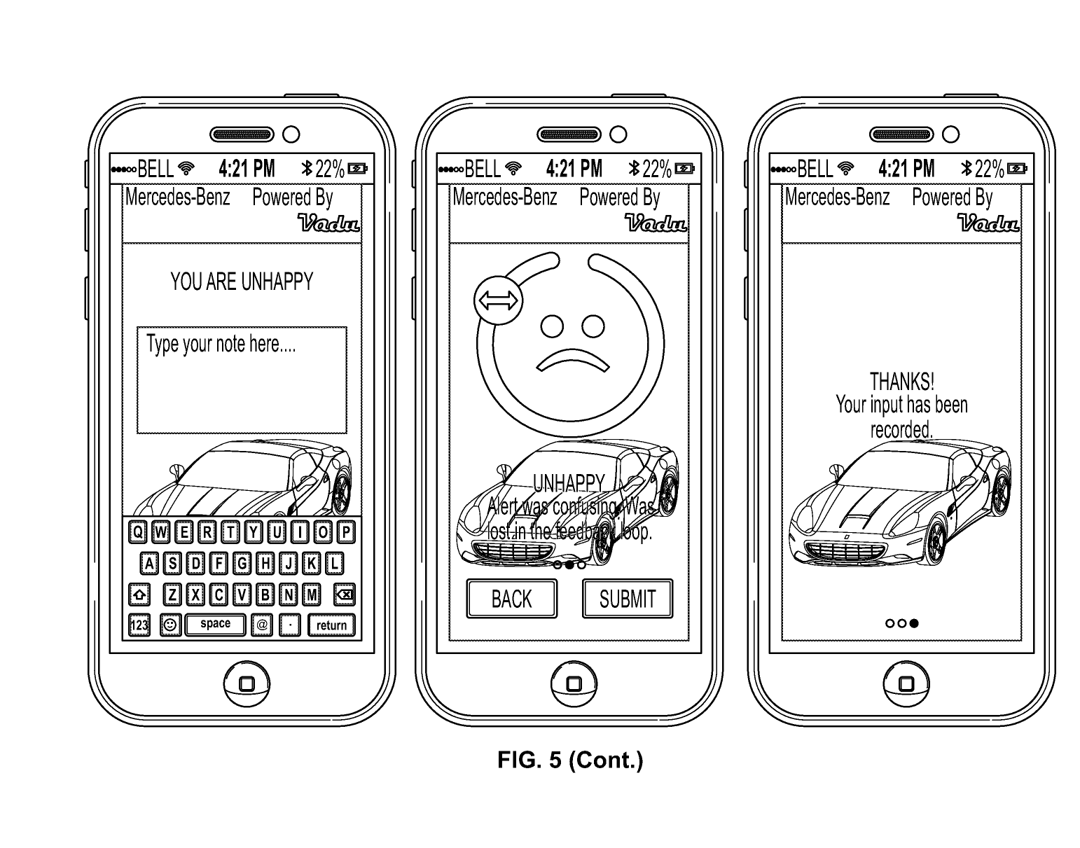

Processing facility 14 is in communication with at least one receiver device 16. Receiver device 16 may be any suitable device such as a computer, a smart phone, a tablet, a laptop or the like computing device that is suitable for receiving a feedback message and generating an output signal as further described below. A feedback message is computer readable file containing computer readable instructions, which directs the receiving device 16 to operate an associated feedback device according to the instructions set forth in the feedback message. For example, a feedback message may direct a smart phone to display an image or a text message, examples of which are shown in FIG. 5.

Receiver device 16 may include a feedback device that may be operated in response to receipt of a feedback message from the processing facility 14. A feedback device may be a display monitor to display information transmitted by processing facility 14, a visual device such as an LED light or similar visual medium to generate a visual cue, an audio device such as a loudspeaker or a buzzer to generate sound, a vibrator to generate mechanical vibrations, or any other device that may provide a human-perceptible output signal, that is an output capable of being perceived by a human sense.

Camera 12 may be located at a commercial facility 13, where a commercial transaction (e.g. a sales transaction) is at least initiated. For example, camera 12 may be located in a showroom at a car or a boat dealership. Locations other than a commercial facility may be used for the location of the camera 12. For example, the camera 12 may be located in a hospital, a medical clinic, a car, a school or some other educational facility, or even inside of a machine such as an MM machine.

In one variation, camera 12 may be configured to be worn by a person (i.e. attachable to a person's clothing). The person wearing the camera may be a salesperson, a quality control person, a sales manager or the like who will be present in the commercial facility 13 while the system 10 operates to provide feedback messages.

Referring to FIG. 2, in another embodiment, a plurality of cameras 12, 12′, 12″ are in communication with the processing facility 14. Each camera 12, 12′, 12″ may be at a different location in the commercial facility 13. For example, the cameras 12, 12′, 12″ may be worn by different persons (e.g. different salespersons).

In one variation of the second embodiment, cameras 12, 12′, 12″ may include at least one camera worn by a salesperson, while the other cameras are fixed in place at different locations in the commercial facility 13. For example, one or more cameras may be located near the displayed products in the commercial facility 13 to capture images of non-verbal responses (e.g. facial expressions) from shoppers.

A camera 12, 12′, 12″ worn by a person (e.g. a salesperson) may be part of a personal article such as glasses, or may be detachably attachable to a person's clothing, for example, to a salesperson's shirt or coat. A camera 12, 12′, 12″, which is not worn by a person may be installed statically (non-movable) or installed on a moving platform that travels automatically around the commercial facility 13 to capture images of shoppers based on a pre-programmed path or a randomly generated path.

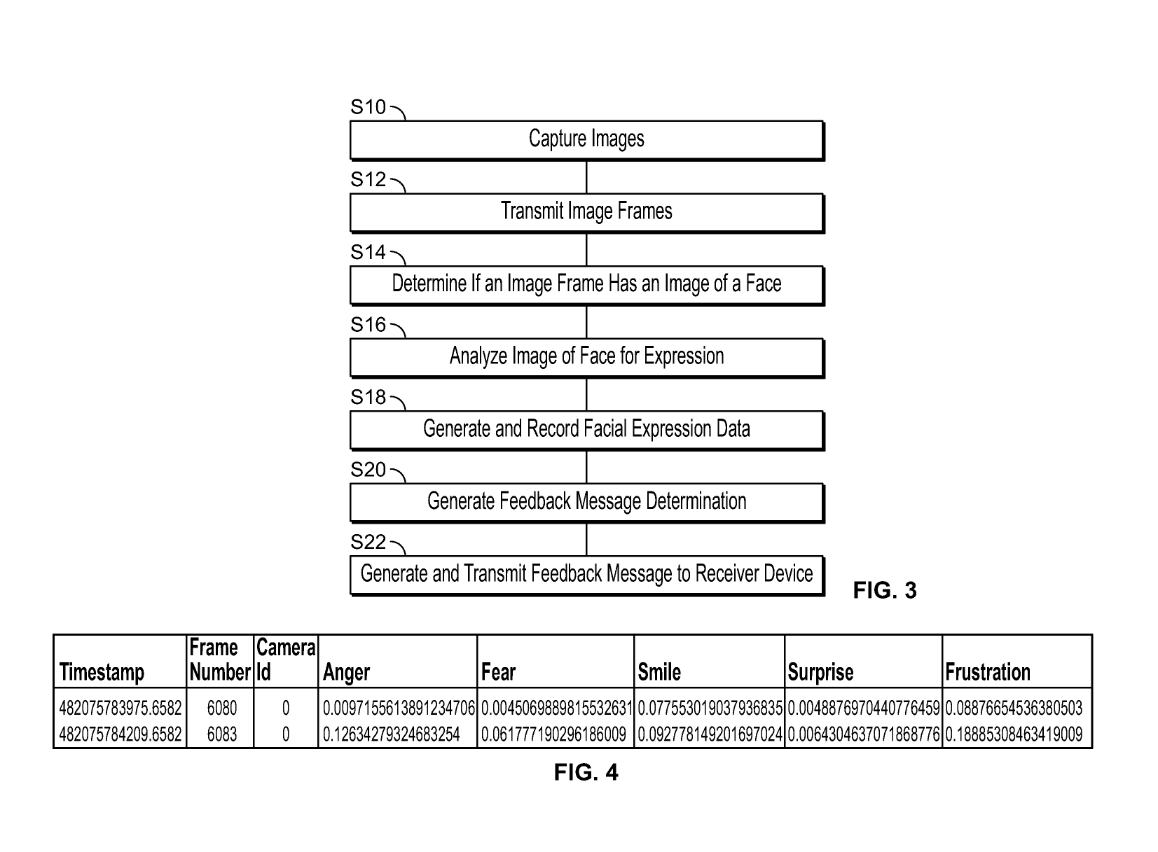

Referring to FIG. 3, a method according to the present invention includes capturing a sequence of images with a camera 12 (S10), and transmitting from the camera 12 the sequence of images as a sequence of image frames to the processing facility 14 (S12). The method further includes determining at the processing facility 14 whether an image frame in the sequence of images includes an image of a person's face (S14), and analyzing the image of the person's face in each image frame to determine if there is a facial expression (S16).

In the preferred embodiment, to carry out S14 and S16, the processing facility 14 may electronically process the image data of each image frame using established methods described, for example, in the OpenCV face recognizer to specifically extrapolate facial features of a person depicted in the image data. Thereafter, processing facility 14, using, for example, Haar-cascade detection, bounds and identifies the face and left and right eyes of the image of the person in the image frame. Then, using 2D AAM statistical modeling processing facility 14 fits a face 33 point landmark model onto the image of the face detected in the image frame using the landmarks computed in the previous detection step. The processing facility 14 preferably records certain facial expressions of the face using the landmark data, and creates a grayscale deformable normalized image of the face in the image frame. Using landmark data, the processing facility 14 performs statistical analysis against codified image data from pre-stored image databases Multi-PIE and MUCT to determine whether there is an expression indicative of one or more of, for example, Anger, Fear, Joy, Surprise, or Frustration. Other potential expressions include, for example, Confusion and Disgust. The processing facility 14 generates facial expression data, and records the facial expression data in a computer-readable file (S18). Processing facility 14 preferably generates a text file containing originating video input file identifiers (e.g. date/time stamp and frame number) and statistical analysis on a frame by frame basis. Steps S12-S18 can be carried out in any suitable manner other than the preferred method described here. The computer-readable file that contains the facial expression data (hereafter “expression file”) may be a text file that includes a plurality of records. Each record contains facial expression data for a respective image frame received from a camera 12. Preferably, the facial expression data are arranged in rows. Each row will contain a record. Each record may include at least a frame number for an image frame, a date stamp for the image frame, a time stamp for the image frame, and a score for each facial expression identified in the image frame.

An example of a text file created by processing facility 14 is shown in FIG. 4. As seen in FIG. 4, the text file 15 includes a plurality of records (which may be arranged in rows), each including a field indicative of an attribute of an image frame. It should be noted that while processing facility 14 preferably creates a text file in which the attributes are arranged in rows and columns, any other format may be used without deviating from the scope of the present invention. That is, any computer-readable file in which the attributes of the image frames are compiled and inter-related would be suitable for the present invention.

Referring to FIG. 4, in the preferred embodiment, the attributes of each image frame include
1: timestamp|2: frame number|3: camera id|4: expression “Anger” score|5: expression “Fear” score|6: expression “Joy” score|7: expression “Surprise” score|8: expression “Frustration” score

It should be noted that a sentiment value is calculated based on the expression scores in each record. Each sentiment value is recorded in an array (further described below) in association with the record that provides the expression scores for its calculation. A sentiment value is indicative of a customer's sentiment (either positive, or negative) that a customer is exhibiting at that moment (which corresponds to the specific date/time stamp and frame number). A sentiment value is calculated for each image frame based on the difference between certain expression scores, for example the difference between expression scores of Frustration and Joy.

According to the present invention, the expression data in the expression file is analyzed by the processing facility 14 to determine whether a feedback message should be generated (S20). If the processing facility 14 determines that a feedback message should be generated, the feedback message is generated and sent to a receiver device 16 in system 10 (S22), where a human-perceptible output signal is generated by a feedback device.

Specifically, the processing facility 14 is configured to aggregate and process the facial expression data to provide a feedback message by applying the following steps.

In order to determine whether a feedback message should be generated, the processing facility 14 actively and continuously reads the expression data from the expression file and generates a real time sentiment score that is calculated by interpretation of the expression data. The sentiment score is based on the sentiment values in the expression file created by the processing facility 14.

Specifically, the processing facility 14 starts by searching for a designated expression file in a specific directory with a specific filename format. The location and the filename of the designated expression file may be in a configuration file, for example. The processing facility may create and record a plurality of expression files. For example, each expression file may be assigned a reference, which may be a number or a name, identifying the expression file by its relationship to its location. For example, an expression file may be associated with a salesperson, or may be associated with its location in the commercial facility 13. The processing facility 14 may be configured to locate a designated expression file in the available expression files. This may be accomplished through parsing or any other suitable method. Once the latest expression file is found, the processing facility 14 opens and reads the expression file. It should be noted that opening and reading are internal processes carried out by one or more computers in the processing facility 14. That is, no text is displayed on a monitor.

Preferably, the processing facility 14 is configured to read the expression files periodically (in regular intervals) and will parse each record (each row if the file is organized in columns and rows) of an expression file using, for example, a CR character.

According to an aspect of the present invention, the processing facility will copy each complete, well-formed row of facial expression data to an internal memory array in a computer readable memory device for further computation and analysis. Each row will contain all attributes of an image frame. The processing facility 14 will discard each incomplete record as well as each record with a duplicate time stamp.

According to an aspect of the present invention, the processing facility 14 will continually append complete records to an internal memory array for a pre-determined and preset segment of time X (hereafter “time segment”). The internal memory array may be defined in a volatile memory device. To define a time segment, the processing facility 14 may subtract the timestamp values of the most recent record and the last processed record recorded in the memory array that would fall within a minimum time segment value as further explained below.

The processing facility 14 will generate a feedback message when there is a minimum expression data density over a time segment X, when a minimum of time segments Y have passed a test as set forth below, and when there is a sustained sentiment score for a duration of Z time.

Time segments are defined discrete intervals of time. The interval of time (which may be defined as X seconds) can be set in a configuration file.

Expression data density may be calculated by counting the number of rows of well-formed data appended into the internal memory array for a time segment.

Sentiment score may be calculated based on the facial expression data in an expression file. Sentiment score may be calculated on a row-by-row basis and appended to another memory array for further analysis.

Sentiment score as used herein is defined as a value (e.g. a number) indicative of the central tendency of the sentiment values for the records appended into the internal memory for a time segment that has passed a threshold test as further explained below. The central tendency is preferably calculated by averaging sentiment values (i.e. determining the arithmetic mean) for the records appended into the internal memory for a time segment that has passed a threshold test as further explained below. Other statistical methods of measuring the central tendency may be used to calculate the sentiment score as long as the calculation results in an acceptable outcome consistent with the present invention. Other statistical methods include, but are not limited to calculating at least one of the median, the mode, the geometric mean, the harmonic mean, the weighted mean, the truncated mean, the midrange, the midhinge, the trimean, and the winsorized mean.

To generate a feedback message, the processing facility 14 conducts a threshold test against the number of rows for a time segment against a minimum desired number, both values being, for example, defined in the configuration file. Furthermore, the processing facility 14 applies a test to determine whether the calculated sentiment score meets a preset criteria, which may be set forth in the configuration file as well.

A threshold test is applied by the processing facility 14, and is considered passed if the number of records counted for a time segment is equal to or exceeds a minimum number of records defined in the configuration file. For example, a time segment may be preset in the configuration file to be 10 seconds. The minimum number of records that are stored in the memory array may be preset to be 25. The threshold test is considered passed if 25 or more records are found in a ten-second time segment. If not, the test for that time segment is not passed, and the processing facility moves on to the next time segment. Thus, for example, the processing facility 14 will test the records in the memory array for time stamps spanning 10:30:25 to 10:30:35 to determine whether there are at least 25 records.

If the test is passed, the processing facility moves to the next segment of time. In the case of the example set forth herein, the processing facility will test the records in the memory array for time segment spanning 10:30:35 to 10:30:45. If the test is passed, the processing facility 14 will move to the next time segment spanning 10:30:45 to 10:30:55. If the threshold test is passed for all three contiguous time segments, then a feedback message is generated and sent to one or more receiver devices 16 by the processing facility if a sentiment score test is passed also as further explained below.

If the threshold test fails for any one of the time segments in the sequence of contiguous time segments, then the processing facility 14 clears the memory array and begins the testing process again. That is, the processing facility 14 is configured to test the records for a predetermined number of contiguous time segments, and if any one of the tests for any one of the time segments in the contiguous series of time segments fails, the processing facility 14 begins the process again.

The processing facility 14 also applies a sentiment score test for the segments of time in the contiguous series of time segments. Specifically, the processing facility 14 determines whether the sentiment score, which is a statistical representation of sentiment values (for example, the average of sentiment values) for the records in the time segments in the contiguous time segments meet a preset criteria. For example, a minimum value may be defined for a sentiment score, and stored in, for example, the configuration file. If a calculated sentiment score for the time segments in the contiguous time segments that have passed the threshold test does not exceed the preset sentiment score value that is stored in the system, then the processing facility 14 passes the time segment. If not, the sentiment score test fails and the processing facility 14 resets (clears the memory array) and begins to evaluate the records in the next segment of time.

Thus, the method could be summarized in the following pseudocode:
if a record count in a time segment>minimum preset record value,
then use time segment and move to the next time segment,
else ignore time segment and reset a counter.
If sentiment score over three contiguous time segments that pass the threshold test less than a minimum preset value (e.g. <0) then generate a feedback message, else reset the counter.

The following example illustrates the process. In the following example, the configuration file is set to test three contiguous time segments, each time segment is 10 seconds, and the minimum required record for each time segment is set at 50.

Scenario 1

| Segment | Time | # records | sentiment score | Min # rec |
|---|---|---|---|---|
| 1 | 10 s | 1 | −0.1 | 50 |
| 2 | 10 s | 0 | 0 | 50 |
| 3 | 10 s | 0 | 0 | 50 |

Segment 1 fails threshold test (insufficient number of records for a segment of time), so the processing facility 14 would NOT trigger to produce a feedback message.

Scenario 2

| Segment | Time | # records | sentiment score | Min # rec |
|---|---|---|---|---|
| 1 | 10 s | 51 | −0.1 | 50 |
| 2 | 10 s | 0 | 0 | 50 |
| 3 | 10 s | 0 | 0 | 50 |

Segment 1 passes threshold test. Segment 2 would not pass the minimum number of records threshold test, so the processing facility 14 would NOT trigger and send a feedback message.

Scenario 3

| Segment | Time | # records | sentiment score | Min # rec |
|---|---|---|---|---|
| 1 | 10 s | 51 | −0.1 | 50 |
| 2 | 10 s | 49 | 0.5 | 50 |
| 3 | 10 s | 51 | −0.1 | 50 |

Segment 1 passes threshold test. Segment 2 does not, so the processing facility would NOT send a feedback message.

Scenario 4

| Segment | Time | # records | sentiment score | Min # rec |
|---|---|---|---|---|
| 1 | 10 s | 51 | −0.1 | 50 |
| 2 | 10 s | 49 | 0.5 | 50 |
| 3 | 10 s | 51 | −0.1 | 50 |
| 4 | 10 s | 51 | 0.05 | 50 |
| 5 | 10 s | 51 | −0.1 | 50 |

Segment 2 fails the threshold test (it does not have the minimum number of records). Segment 3, 4, 5 pass the threshold test (have the minimum number of records) and the sentiment score test (the average sentiment value for segments 3, 4, 5 is less than 0), so the processing facility 14 WILL generate and send a feedback message at the END of segment 5.

It should be noted that the minimum interval of time of a time segment, the minimum number of records of each time segment, the number of contiguous time segments, and the maximum sentiment score for a time segment can be adjusted to achieve the needed resolution and accuracy before a feedback message is sent to a receiver device 16. That is, although the examples provided herein are based on a 10 second time segment, a minimum of 25 records or 50 records, and three contiguous passing time segments with a sentiment score of less than zero, the method according to the present invention is not limited to these numbers.

The processing facility 14 may actively output expression calculation activity to a log file recorded in a non-transitory computer readable memory location at the processing facility 14 or elsewhere for further analysis and audit. The expression calculation activity may include the following information:
1. Partially passed—output showing counts by time segment and a failed test notification
2. Successfully triggered—output showing truncated time stamps and a successful endpoint feedback message (e.g. JSON post).
3. Suppressed events
4. Spike events

The processing facility 14 can be configured to transmit a feedback message to a receiver device 16 associated with a designated party (e.g. a manager, a salesperson, a service person, etc.) in real-time and automatically. Preferably, the feedback message includes some details. The details may include signal type, signal time and camera location. A feedback message may be delivered through any suitable system, for example:
i. an email system;
ii. an SMS;
iii. a JSON (Java Script Object Notation) endpoint.

Other systems may be used to deliver a feedback message. For example, a system implemented with at least one of XML—eXtensible Markup Language (e.g. BOX—Binary optimized XML), YAML (Yaml Aint Markup Language), which is similar to JSON but streamlined, Google Protocol Buffers (GPB), which is a newer concept of XML, CSV, which is suited for specific tabularized data and TXT (TeXT file—legacy type) can be used. A system used may generate a digital message (i.e. a computer readable digital file), which is readable by a processor-enabled device (e.g. a smart phone) to display a message on a visual monitor.

The processing facility 14 may be configured to receive and record the response or responses from the designated recipient of the feedback message. For example,
a) using a guided step-by-step process (e.g. Active intervention to acknowledge/ignore signal; 2. Pre-intervention assessment rating; 3. Post-intervention assessment rating; 4. Additional information regarding interaction (for example notes); 5. Active acknowledgement of server receipt of information).
b) information captured is transmitted via network (or internet as available) to a remote server and stored in normalized format in a proprietary secure database.

The processing facility 14 may also be configured to analyze the actions of the designate party and provide interaction data.

Preferably, the processing facility 14 runs the process continuously unless the process is terminated intentionally by a user or by an abnormal exit.

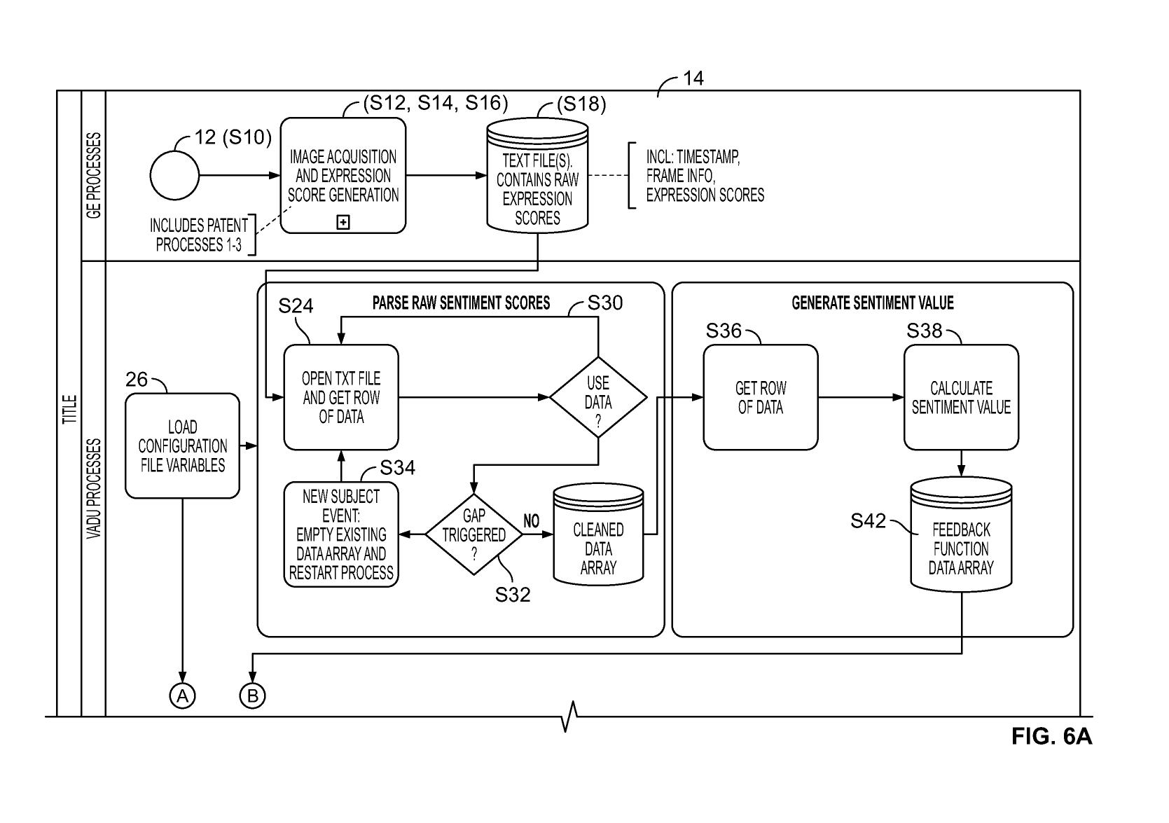

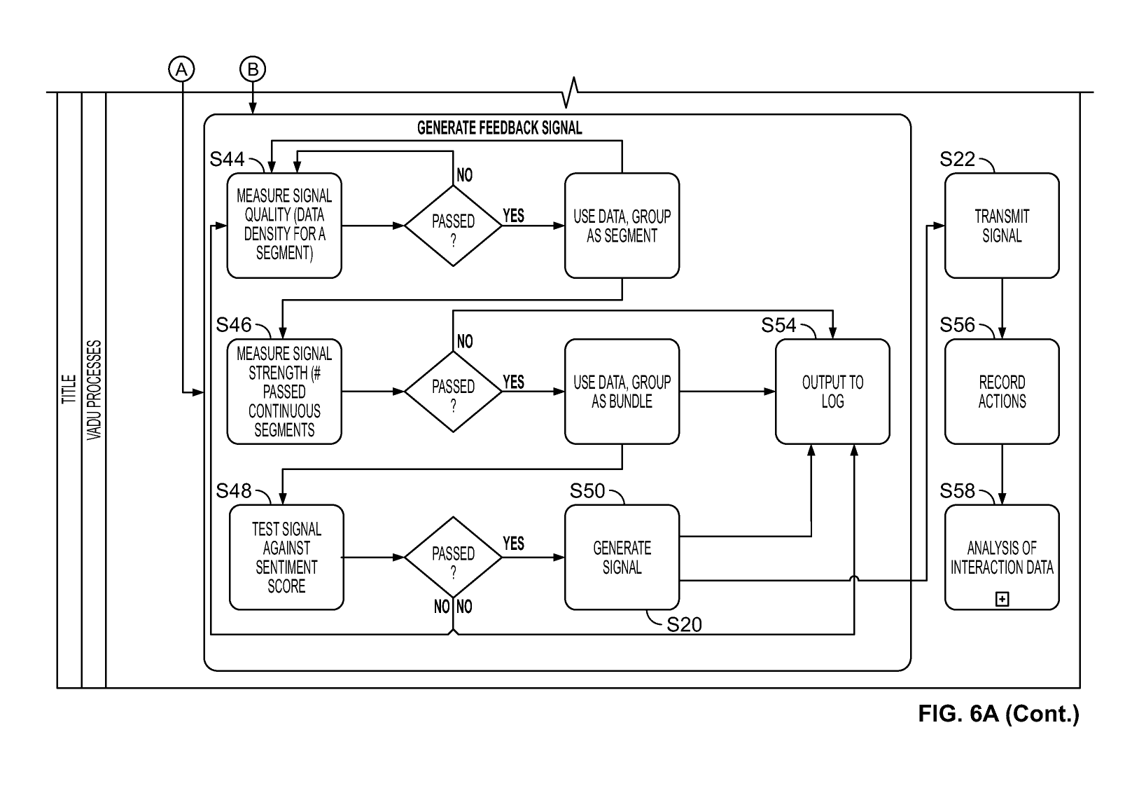

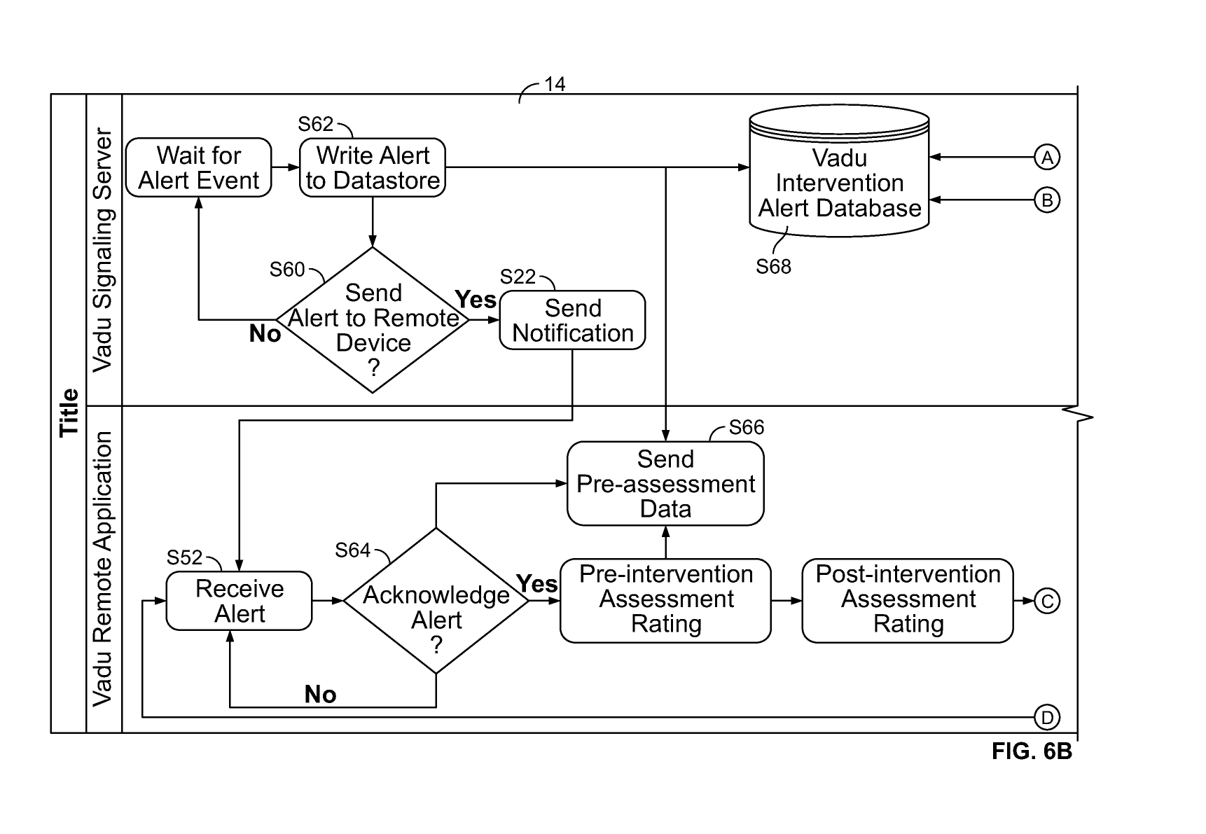

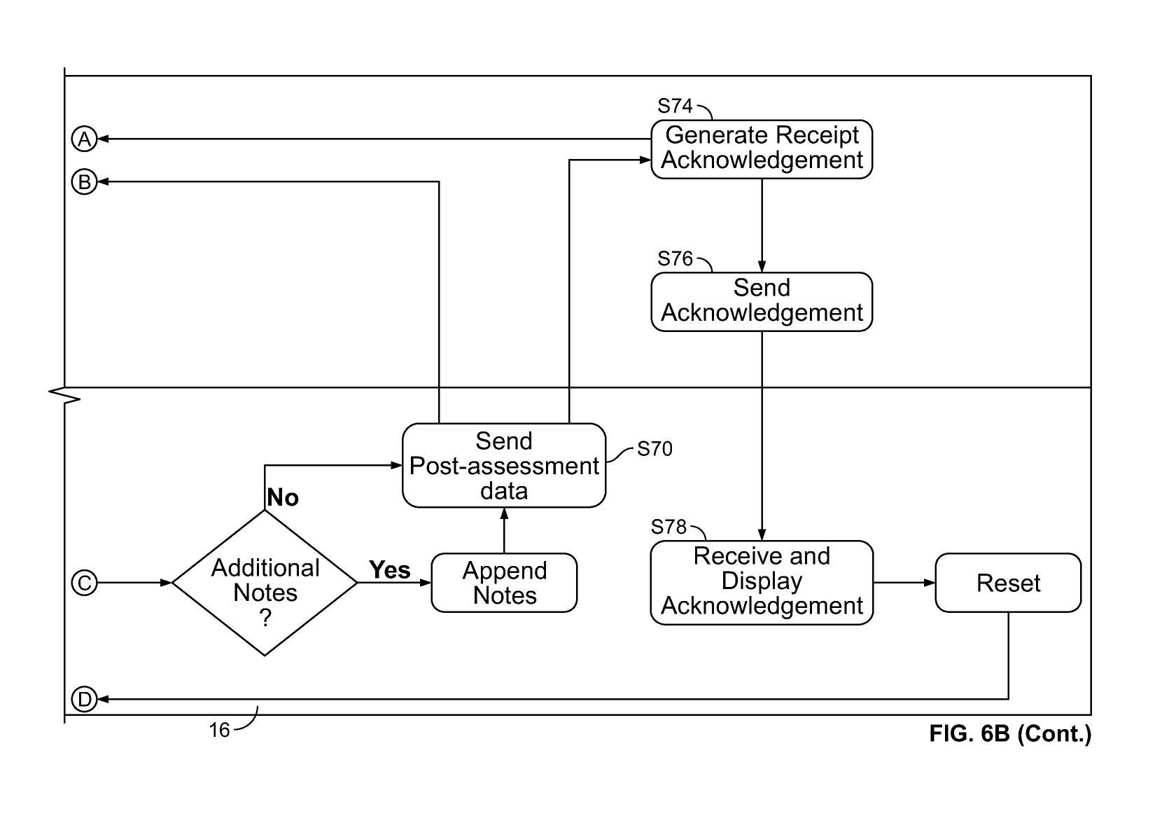

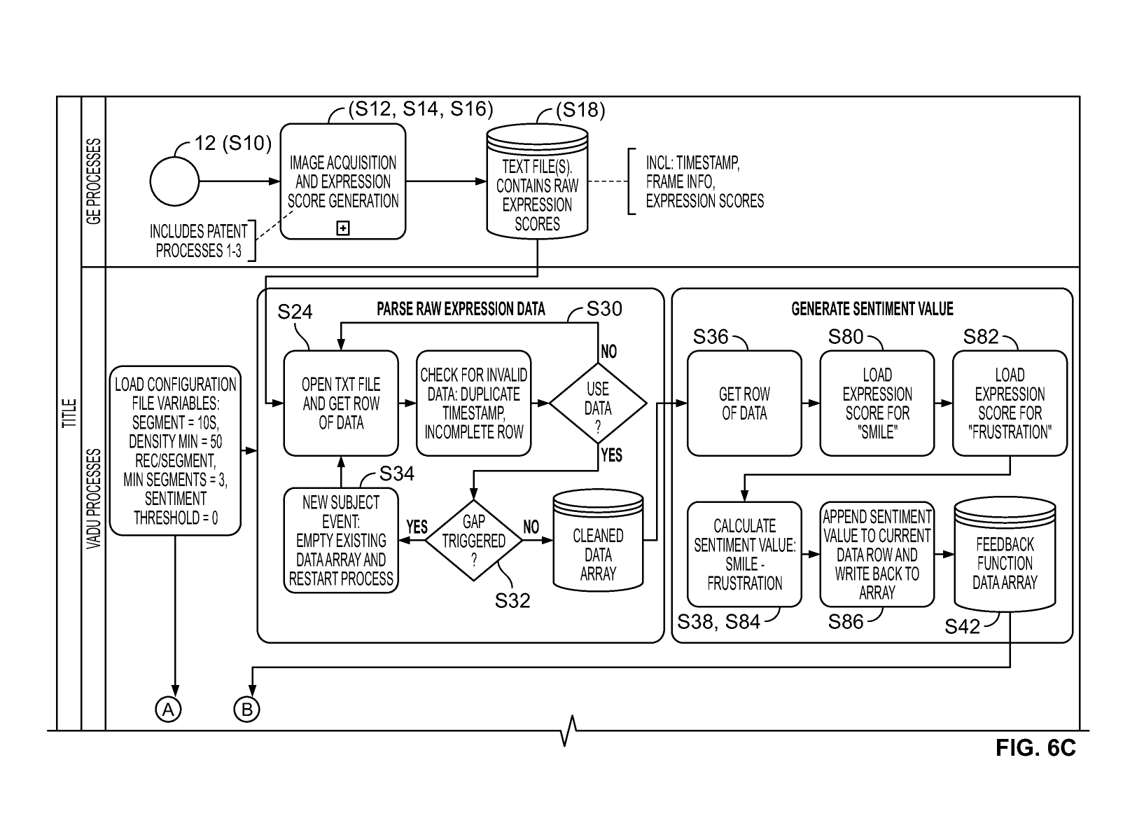

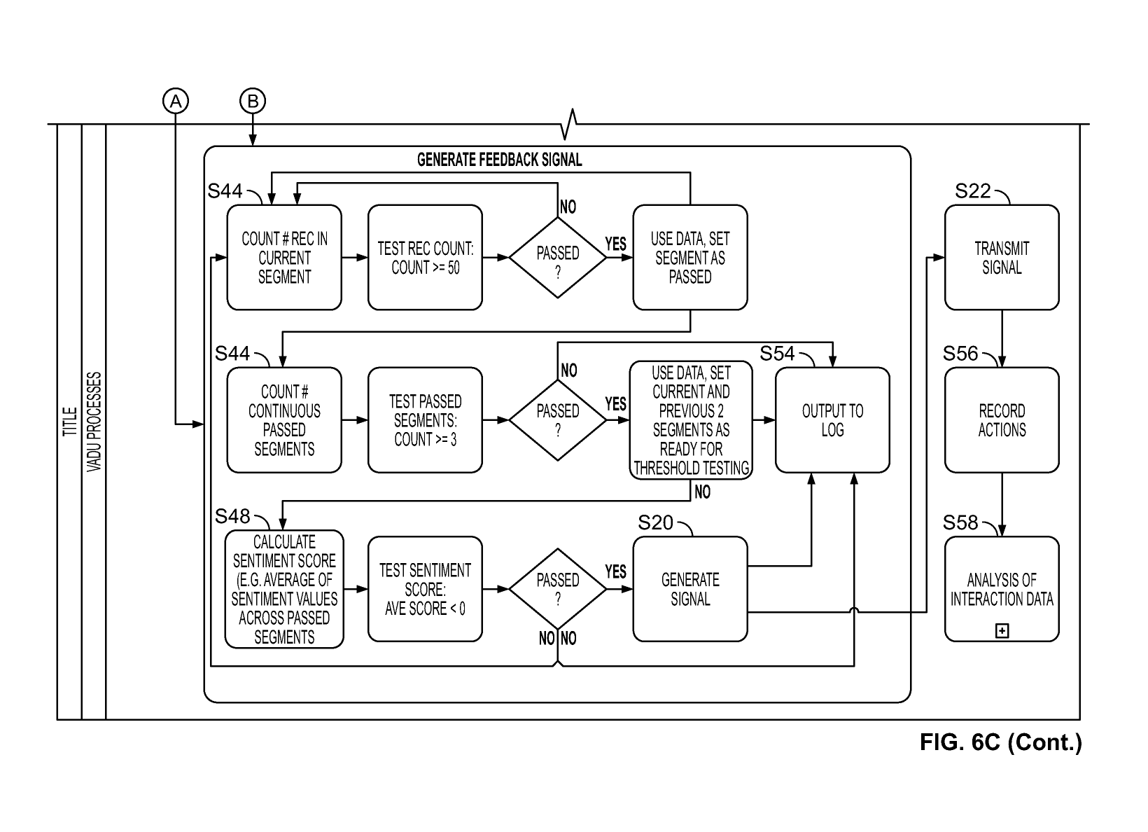

FIGS. 6A and 6B, in which like numerals identify like steps as previously described, illustrate a process according to the present invention in greater detail.

Referring to FIG. 6A, the following are performed by the processing facility. After an expression file is generated (S18), an expression file is opened (S24), and a configuration file is loaded (S26). The configuration file may be loaded first as it may contain information for locating the expression file within the system as previously described. Thereafter, it is determined whether the data in the expression file (S28) is suitable for use by parsing (S30) as previously described. If a gap in the data is detected (S32), the data array is cleared (S34). If not, and it is determined that the data does not have a gap, then a first row of data is obtained from the expression file (S36), a sentiment value is calculated (S38) for the row of data, and the sentiment value so calculated is added to the row of data in the array as previously described. The array is then completed on a row by row basis as described. A completed array will include each row of data each with a respective a sentiment value. The completed array is then forwarded to determine whether a feedback signal should be generated (S42). To determine whether a feedback signal should be generated, first the signal quality is measured by analyzing the data density for the segment (S44). If there is an appropriate amount of records as prescribed in the configuration file, then the signal strength is measured by determining whether the number of contiguous segments meets the minimum requirement as set forth in the configuration file (S46). If so, the sentiment score test is applied against the contiguous segments (S48). If the sentiment score test is passed, it is determined that a feedback signal should be generated (S50), a feedback message is transmitted (S22) to a receiver device 16 (FIG. 6B) to generate a feedback signal.

Referring now to FIG. 6B, when receiver device 16 receives the instruction to generated a feed back signal (S52), it generates a feedback signal.

Optionally, failure of any one of the tests (the signal quality test, the signal strength test, and the sentiment score test is stored in a log file (S54) at a memory location in the processing facility 14 or any other suitable memory location. Furthermore, optionally, the generation of the feedback message and all associated actions may be stored (S56) at a memory location at the processing facility 14 or any other suitable location, and the data may be analyzed (S58).

Referring specifically to FIG. 6B, the processing facility 14, before sending the feedback message, may determine whether to send the feedback signal (S60) and then send the feedback message (S22). If the processing facility 14, determines that a feedback message should not be sent, then it waits for another feedback message (S62).

Receiver device 16 may be configured with software (such as an APP) to perform the following. The receiver device 16 is configured to permit the user to acknowledge the receipt of the feedback message (S64). The user may, for example, press/click or otherwise make an appropriate selection indicating acknowledgment of the alert via a user interface generated by the feedback device 16. The user of the receiver device 16 may send a pre-intervention rating to the processing facility 14 via the receiver device 16 (S66), which when received by the processing facility is stored in an intervention database (S68) located at the processing facility 14 or another location. The user of the receiver device 16 may also send a post-intervention rating via the receiver device 16 (S70) along with additional comments and notes (S72) to the processing facility 14, which may be stored in the intervention database. Upon receipt of the post-intervention rating, the processing facility 14 generates (S74) and sends (S76) an acknowledgement receipt to the receiver device 16, which, when received by the receiver device 16, is displayed (S78). The receiver device 16 is then ready to receive another feedback message. A copy of the acknowledgement from the processing facility 14 may be then stored in the intervention database (S78).

Referring now to FIG. 6C, in which like numerals identify like steps performed by the processing facility 14, in one preferred embodiment sentiment value for a row of data is calculated by obtaining the expression score for joy (S80), obtaining the expression score for frustration (S82), and subtracting the frustration score from the joy score (S84). The sentiment value so calculated is then added the data from the row of data and written into the array (S86). In this embodiment, before determining whether data is to be used, the expression file is checked for duplicate time stamps and incomplete rows (S88) as previously explained. Also, in this embodiment, the signal quality is measured by counting the number of records in the segment and determining whether the counted records meets a minimum number set in the configuration file (e.g. 50), the signal strength is measured by counting the number of contiguous segments and determining whether the count meets the minimum number set in the configuration file (e.g. 3), and the sentiment score test is carried out by calculating the sentiment score for the contiguous segments as described earlier and determining whether a threshold value has been reach (e.g. whether the score is less than zero).

The following is an example of the methodology leading to the selection of the values for the parameters used for the configuration file in a the preferred embodiment of the present invention. It should be understood that the actual numbers used are preferred and provided herein as an illustration. The following example is provided to illustrate how the efficacy of a system according to the present invention is improved by the tests described herein.

Sentiment Value Calculation Per Record

As explained, in the preferred embodiment, the expression file contains expression variables with requisite scores for Anger, Joy, Frustration, Fear, Surprise. Each records provides a value for a respective expression value in the range 0-1. The time gap between each record is due to the image capture infrastructure (i.e.: quality, spec, etc.) and whether the subject is in the image frame.

Typically, a record could be added to the text file every 1/10th of a second. The following tests were conducted to determine, which value or combination of values would provide the needed accuracy in providing a feed back message.

Test A: Using Frustration Expression Score Only

Given the desire to intervene during a negative subject (e.g. customer) experience in an interaction, the frustration score was evaluated only to determine whether that a sentiment score based on that expression variable would lead to reasonably accurate results.

It was discovered that taking the frustration variable as the sole basis for scoring was problematic because often, when reviewing the subject in video (i.e.: human observation), it could not be determined with confidence that the customer was indeed frustrated.

Test B: Using Surprise, Anger, and Fear Expression Scores

The surprise, anger, and fear scores, along with the frustration score, are considered largely “negative” expression scores. Evaluating the records for multiple subjects using these variables was tested.

Each record has a numeric value in the range 0 and 1 for every expression variable. These particular variables rarely rose above 0.25. The delta (i.e. the changes) and the magnitude of these variables was often significantly less than joy or frustration. That is, these value reported for these variable did not appear to change much from record to record and the values appeared to stay essentially the same.

Test C: Calculating Joy Minus Frustration

The joy scores and the frustration scores had the most volatile scores, meaning that they were more variable from record to record. Thus, it was believed that when frustration score was high, the joy score should be low (and vice versa), and thus testing based on those score would be an accurate way to classify “dissatisfied” vs “satisfied” customers.

When comparing the output data from the expression file with subjects in the observed video it was found that customers that appeared most dissatisfied also had low joy scores and high frustration scores. Furthermore, subjects whose frustration scores were greater than joy scores over a period of time were deemed to be the most “upset” customers.

Thus, in the preferred embodiment, the two most volatile (i.e. variable) expression scores were used to determine satisfaction or dissatisfaction.

Record Density

The test was conducted to determine how many records in the expression file is needed for given segment of time to ensure that there exists adequate record counts for a reliable calculation.

For example, if the subject (e.g. a customer) moves out of the camera range for a “short” period of time and then re-enters, it must be ensured that the system does not (necessarily) generate a feedback message that relies on too few records for an expression score calculation.

Test A: No Minimum

Sentiment scores were calculated for a subject irrespective of how many records were found in a segment of time.

This test produced too many triggers resulting from too few values contributing to a feedback message. As a result, too many feedback messages were being generated, which did not necessarily correspond to the state of mind of the subject.

Test B: 100 Records

Sentiment scores were calculated for a subject if and only if a minimum (in this case 100) records were found in the expression file in a segment of time.

While this test was an improvement, too many records were required to trigger a feedback message. As a result there were subjects (e.g. customers) that appeared visibly distressed in the video, but feedback messages were not being generated. It was assumed that there was not enough suitable data in the segment of time containing at least 100 records to properly classify the state of mind of a customer and consequently a feedback message was not generated. This test showed that, contrary to conventional thinking, increasing a sample size (number of records) did not necessarily lead to a better resolution as further explained below.

Test C: 50 Records

Sentiment Scores were then calculated for a subject if and only a minimum (in this case 50) records were tested for a segment of time. The minimum number in this test was less than the minimum number in Test B.

Surprisingly, it was found that the lower minimum number of records that were tested produced better results, meaning that the system produced feedback messages that corresponded well with the state of mind of the subject. This test proved that, surprisingly, there is an appropriate maximum number of records that will serve as a minimum record number for the record density test, and that, contrary to conventional thinking in statistics, more records (i.e. a larger test set) does not lead to better results. Furthermore, this test showed that a minimum record number is a result effective variable, which was not known before this test, and that testing for all the records in a segment of time without some minimum number of records could not provide effective results.

Time to Signal

As explained above, an accumulation/calculation of records during a segment of time is needed prior to enabling a signal/alert. Testing various time periods was needed to determine an adequate amount of time to be confident that the expressed (and recorded) sentiments were sufficient to confidently generate a feedback message.

Test A: 2 Minute Calculation

First, it was hypothesized that two minutes may be an adequate segment of time to observe an interaction and become confident that the behavior recorded in the expression file corresponded accurately with what was observed in the video.

Two minutes turned out to be too long. By the time 2 minutes had elapsed there were a significant number of cases where the subject issues could no longer be remedied. Thus, shorter time intervals needed to be evaluated.

Test B: 1 segment (30 Seconds of Calculation)

In view of Test A, the segment of time was shortened to 30 seconds. It was hypothesized that 30 seconds was enough time to determine with confidence that the subject (e.g. customer) was dissatisfied, requiring intervention to remedy the situation.

However, it was discovered that the mere combination of record density and segments was not accurate. For example, 50 records in the first 5 seconds of a 30 second interval would have triggered a feedback message (ie: negative Scores), but in the next 25 seconds of that 30 second interval the subject would turn out to be happy/satisfied (ie: positive scores).

Test C: 3 (10 Second Segments Calculated Separately)

Based on Tests A and B, it was concluded that a shorter time period than two minutes was necessary to ensure that feedback messages were generated in “real time”. It was concluded that 30 seconds was enough time to determine a customer was dissatisfied, and could give a staff member confidence that intervention would be advisable to remedy the situation. However, as a further refinement, the 30 second period was then further broken into three distinct 10 second segments of time with which to calculate the sentiment scores, because as stated above, the mere combination of record density in a single block of time of 30 seconds was not deemed adequate.

Multiple 10 second segments allowed for the calculation of sentiment scores during 3 distinct but contiguous subject interaction periods. It was believed and confirmed that negative emotion in each of those three segments would be more accurate than a test conducted during a 30 second interval. The results indicated that the calculation based on three contiguous time segments corresponded better with what was observed in the video, indicating a more accurate calculation.

Calculating Sentiment Score

The purpose of this test was to determine how to evaluate the sentiment values found in the data set that passed the signal quality test (minimum record density) and signal strength test (minimum number of contiguous segments that passed the signal quality test).

Test A: Average of sentiment values per segment

The average values for sentiment values over a segment were obtained to determine if, overall, the values were positive or negative.

The simple averaging indicated strong correlation to what was observed in the video (e.g. a customer with positive scores, did appear happy in the observed video, while a customer with a negative score did in fact appear distressed).

Test B: Maximum of Sentiment Value<Set Limit

The test was to use one very “negative” record to generate a feedback message immediately.

This approach proved too sensitive because of the volatility in the expression score data. It was found that because of micro expressions (i.e.: every 10th of a second) when, for example, a person moved from a neutral face to a joy and a 1/10th second negative record could be produced. This was far too sensitive to generate a feedback message reliably.

Test C: Slope of a Given Set of Records (Sentiment Values) Over Time.

It was hypothesized that the trend of a subject's sentiment score(s), going from positive to negative, would be an accurate way to trigger a feedback message.

The challenge was how to set up the parameters with which to evaluate slope of a line given that each customer has a different starting and end point, and that the slope for each segment (e.g. 30 second segments) of an interaction is always changing vs. the slope of the overall transaction (which if calculated would be too late to generate a feedback signal).

Thus, Test A proved to be a simple but effective way of obtaining useful and reliable information based on which a feedback message could be generated.

In a method according to the embodiment disclosed herein, joy and frustration expression scores were selected because they were more volatile, while the other scores showed little fluctuation. Thus, it was decided that more information was contained in the volatile scores. It is to be appreciated that volatility of a score may be due to the nature of the interaction. The nature of the interaction can provide a context based on which a system according to the present invention could provide a response.

For example, a person visiting an auto repair shop and interacting with the mechanic may not exhibit enough positive emotion (joy) that could provide a basis for generating a signal. Such a situation may not have any relationship with the quality of service that is being provided, but may be due to the nature of the interaction. That is, the person may be exhibiting negative emotions simply because his car is broken, and not for any reason related to the auto repair shop. In such a case, examination of a positive emotion (joy) and a negative emotion (frustration) may not be a proper way to evaluate satisfaction. One could, using a method as described here, identify, based on the data set, expression scores that are indicative of the customer's satisfaction. For example, volatility could be used to identify expression scores that could include the proper information that reflect the context of the interaction, and then test the calculations using the selected expression scores by examining the videos as described earlier.

Thus, a system according to the present invention could be configured to respond based on the context associated with the interaction. For example, the camera identification number could be used to determine the location of the interaction, and based on the location of the interaction an appropriate program would be loaded and executed by the processing facility, which is configured to calculate a sentiment score for that context. Other identifying information could be used for selection of the appropriate program that corresponds to the expected context of the interaction. For example, a customer identification number or a location identification could be used to select the proper program. For instance, a customer identification number could indicate whether the interaction is taking place at a physician's office, an insurance agent's office or a car dealership. The location identification (e.g. a number for the showroom at an auto dealership) could also be used to select the proper program for execution by the processing facility within a site that has different locations for different functions (i.e. different services). Thus, a system according to the present invention could be adapted to provide a response by taking the expected context of the interaction into account.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A system comprising at least one camera, a processing facility (PF) that includes at least one computer in communication with said camera to receive a sequence of image frames from said camera, and at least one receiver device in communication with said PF, wherein said processing facility is configured to generate expression data for the image frames and record said expression data in a memory array, said expression data including at least a sentiment value for each image frame, and wherein said PF is configured to send a feedback message to said receiver device when said PF determines that the memory array includes, for at least a minimum number of contiguous time segments, a minimum number of image frames for each respective time segment in the contiguous time segments, and a sentiment score for the image frames in the contiguous time segments satisfies a preset criteria.

2. The system of claim 1, wherein said PF is configured to determine whether an image frame includes an image of a face of a person and is configured to determine whether the image includes a facial expression indicative of at least one emotion selected from the group consisting of anger, fear, joy, surprise, frustration, confusion and disgust.

3. The system of claim 1, wherein said PF is configured to generate and record a computer-readable expression file, said expression file including expression data for each image frame, wherein said expression data is organized in rows and columns.

4. The system of claim 3, wherein said PF is configured to record only a complete row of expression data in said memory array.

5. The system of claim 1, further comprising a configuration file stored in a non-transitory computer-readable memory device of said processing facility, said configuration file including a value for said minimum number of contiguous time segments, a value for said minimum number of image frames in each one of said contiguous time segments, and said preset criteria is satisfied.

6. The system of claim 1, wherein said receiver device includes a feedback device that generates a human-perceptible output signal.

7. The system of claim 6, wherein said feedback device is one of a display monitor, a vibrator, a loudspeaker, a buzzer, and light emitter.

8. The system of claim 1, wherein said feedback message is a digital message readable by a device configured to process digital files and configured to display a message on a visual monitor based on the digital message.

9. The system of claim 8, wherein the digital message is one of an e-mail message, an SMS, a JSON message, an XML message, a YAML message, a GPB message, a CSV message, and a TXT message.

10. A method of generating a feedback message indicative of an emotional state, comprising:
capturing a series of images and producing a sequence of image frames with a camera, said image frames including an image of a person's face;
receiving said sequence of images at a processing facility that includes one central processing unit or a plurality of central processing units;
generating with a central processing unit of said processing facility, expression data for at least some of said image frames, said expression data including at least a sentiment value;
recording said expression data of each image frame in a memory array defined in a computer-readable memory device;
determining, with a central processing unit of said processing facility, whether, for a minimum number of contiguous time segments, a minimum number of images frames is recorded in said memory array for each respective time segment;
determining, with a central processing unit of said processing facility, whether an average of sentiment values for said image frames in said contiguous time segments satisfies a preset criteria; and
sending a feedback message to a receiver device from said processing facility when it is determined that the memory array includes, for at least a minimum number of contiguous time segments, a minimum number of image frames for each respective time segment, and it is determined that a segment score for the image frames in the contiguous time segments satisfies said preset criteria.

11. The method of claim 10, further comprising determining at said processing facility whether an image frame includes an image of a face of a person and determining at said processing facility whether the image includes a facial expression indicative of at least one emotion selected from the group consisting of at least anger, fear, joy, surprise and frustration.

12. The method of claim 10, further comprising generating and recording a computer-readable expression file at said processing facility, said expression file including expression data for each received image frame, wherein said expression data is organized in rows and columns.

13. The method of claim 12, further comprising recording only a complete row of expression data in said memory array.

14. The method of claim 10, further comprising storing a configuration file in a memory location in said processing facility, said configuration file including a value for said minimum number of contiguous time segments, a value for said minimum number of image frames in each one of said contiguous time segments, and a sentiment score value limit, which sets a limit for the sentiment score generated using said sentiment values.

15. The method of claim 10, further comprising generating a human perceptible signal with a feedback device of said receiver device.

16. A facility, comprising:
a showroom having therein at least one camera, said camera being in communication with a system that includes a processing facility (PF) having at least one computer in communication with said camera to receive a sequence of image frames from said camera, and at least one receiver device in communication with said PF, wherein said processing facility is configured to generate expression data for the image frames and record said expression data in a memory array defined in a computer-readable memory device, said expression data including at least a sentiment value, and wherein said PF is configured to send a feedback message to said receiver device when the memory array includes, for at least a minimum number of contiguous time segments, a minimum number of image frames for each respective time segment, and an average value of sentiment values for the image frames in the contiguous segments of time satisfies a preset criteria.

17. The facility of claim 16, wherein said PF is configured to determine whether an image frame includes an image of a face of a person and is configured to determine whether the image includes a facial expression indicative of at least one emotion selected from the group consisting of anger, fear, joy, surprise and frustration.

18. The facility of claim 16, wherein said PF is configured to generate and record a computer-readable expression file, said expression file including expression data for each image frame, wherein said expression data is organized in rows and columns.

19. The facility of claim 18, wherein said PF is configured to record only a complete row of expression data in said memory array.

20. The facility of claim 16, further comprising a configuration file stored in a memory location in said processing facility, said configuration file including a value for said minimum number of contiguous time segments, a value for said minimum number of image frames in each one of said contiguous time segments, and wherein said preset criteria is satisfied.

21. The facility of claim 16, wherein said receiver device includes a device that generates a human-perceptible signal.

22. The facility of claim 21, wherein said device is one of a display monitor, a vibrator, a loudspeaker, a buzzer and a light emitter.

23. The facility of claim 16, wherein said feedback message is a digital message.

24. The facility of claim 23, wherein said feedback message is one of an e-mail, an SMS, a JSON message, an XML message, a YAML message, a GPB message, a CSV message, and a TXT message.
